(19) United States
(12) Patent Application Publication
(10) Pub. No.: US 2008/0069654 A1
(43) Pub. Date: Mar. 20, 2008

(54) Countersink drill bit for composite wood

(76) Inventor: Carl A. Chasse, Stafford, CT (US)

Correspondence Address: DICKSTEIN SHAPIRO LLP, 1825 EYE STREET NW, Washington, DC, 20006-5403, US

(21) Appl. No.: 11/522,429

(22) Filed: Sep. 18, 2006

(51) Int. Cl. B23B 51/00

(52) U.S. Cl. 408/227

(57) ABSTRACT

The invention relates to a countersink bit for composite wood. The countersink bit comprises a generally cylindrical body having at one end a cylindrical portion and at the other end an engagement portion. The countersink bit has a conical portion at an end of the enlarged cylindrical portion, and the conical portion comprises a shallow cutting face defined by a cutting edge and a bottom edge. The conical portion further comprises a shallow split surface, defined on one side by the bottom edge and on the other side by an edge of a flank. In the countersink bit, the split surface and the shallow cutting face define a reservoir which, in use, accumulates cut composite wood material.

### BACKGROUND

The present invention relates generally to a countersink bit for use with wood materials. In particular, the present invention relates to a countersink bit for use with composite wood materials, and a countersink bit that controls the depth of its penetration into such materials.

Countersink bits are tools that are used for forming an opening in a material, where the opening is typically an annular chamfer around a circular hole. Countersink bits typically comprise a cylindrical body having cutting surfaces at one end. Countersink bits can be manufactured for use with a variety of materials. The Countersink bit of the invention is intended for use with composite wood material.

In construction and furniture building involving wood products, the use of composite wood material is becoming more common. Some composite wood materials are made entirely from post-consumer polyethylene waste such as bottles and other recycled plastics. Other composite wood materials are manufactured by mixing wood and other materials such as glass, steel, and carbon fibers with a suitable binder to vary the characteristics of the final material. Composite wood materials are used to construct everything from cabinets to decks. Such composite wood materials are made by various processes. For example, composite wood material may be made by blending recycled plastic resins with sawdust and extruding the blended mixture into standard lumber sections.

Composite wood materials have many advantages over wood. For example, composite wood materials are often stronger and more durable then even pressure treated lumber. Many composite wood materials also offer better resistance to moisture, corrosive substances, termites and other insects, and other environmental strains that often prove to be detrimental to wood.

Countersink bits are used for making an opening in a work piece prior to installation of a screw, or other type of fastener, into the same opening. The opening created by the countersink bit defines an area that accommodates the head of the screw, once the screw is fully inserted into the work piece. The goal, typically, is to provide an opening of sufficient depth to allow the head of the screw to seat even with the top surface of the work piece. Such a configuration results in a work piece having a smooth surface, which is functionally and aesthetically desirable.

A countersink opening that is made too deep by a countersink bit is not desirable. Such an opening is illustrated in FIG. 9, that shows a material 60 having an opening 62 cut therein by a conventional countersink bit. The opening 62 was cut too deep into the material 60 by distance 64. A screw 68 seated in the opening 62 is shown in FIG. 11. The screw 68 is seated below the top surface 70 of the material 60 by a distance approximately the same as distance 64. As such, when the crew 68 is seated in opening 62 the top surface 70 is not smooth, which is undesirable.

Depth control is needed for a countersink bit so that a countersink opening of proper depth can be formed, such as the opening identified by numeral 66 in FIG. 10. Opening 66 is cut precisely to accommodate the head and under-head surfaces of a screw. The opening 66 is not cut too deep into the material 60. A screw 68 seated in opening 66 is illustrated in FIG. 12. The screw 68 seated in opening 66 is flush with the top surface 70 of the material 60. Thus, it is desirable to have a countersink bit with a depth control feature to make openings 66 of proper depth to accommodate the head of a screw such that the screw sits flush with the top surface 70 of the material 60.

What is needed is a countersink bit that has a depth control feature, for use with composite wood materials.

### SUMMARY

In one aspect of the invention there is provided a countersink bit for composite wood. The countersink bit comprises a generally cylindrical body having at one end a cylindrical portion and at the other end an engagement portion. The countersink bit has a conical portion at an end of the cylindrical portion, and the conical portion comprises a shallow cutting face defined by a cutting edge and a bottom edge. The conical portion further comprises a split surface, defined on one side by the bottom edge, and a flank surface defined by the cutting edge and the split surface. In the countersink bit, the split surface and the shallow cutting face define a reservoir which, in use, accumulates cut composite wood material.

In another aspect the invention provides a countersink bit having a depth control feature for composite wood, comprising a generally cylindrical body having at one end a cylindrical portion and at the other end an engagement portion. The countersink bit has a conical portion at an end of the cylindrical portion, wherein the conical portion has a depth control feature. The depth control feature comprises a shallow cutting face, defined by a cutting edge and a bottom edge, and a split surface, defined on one side by the bottom edge. The split surface and the shallow cutting face define a reservoir which, in use, accumulates cut composite wood material.

In yet another aspect, a method of using a countersink bit in composite wood is provided. The method comprises providing a countersink bit having a conical portion with a shallow cutting face and a split surface, wherein the split surface and the shallow cutting face define a reservoir. The method further comprises providing a rotational force to the countersink bit, and engaging the countersink bit with a composite wood material. The method also comprises making a countersink opening in the composite wood material, while cut portions of the composite wood material are accumulated in the reservoir. According to the method of the invention, the countersink bit stops penetrating into the countersink opening when the reservoir is substantially filled with the cut portions of the composite wood material.

These and other features and advantages of the invention will be more clearly understood from the following detailed description and drawings of preferred embodiments of the present invention.

### BRIEF DESCRIPTION OF THE DRAWINGS

FIG. 1 is a side view of a countersink bit according to a preferred embodiment of the present invention.

FIG. 2 is a bottom view showing the conical portion of the countersink bit of FIG. 1.

FIG. 3 is a detailed view of a portion of the countersink bit of FIG. 1.

FIGS. 4-8 are illustrations of the countersink bit of FIG. 1 in use with a composite wood material.

FIG. 9 is a side sectional view of a material with a countersink hole made by a conventional countersink bit.

FIG. 10 is a side sectional view of a material with a countersink hole made by a countersink bit in accordance with the present invention.

FIG. 11 is a side sectional view of a screw seated in the countersink hole of FIG. 9.

FIG. 12 is a side sectional view of a screw seated in the countersink hole of FIG. 10.

### DETAILED DESCRIPTION OF PREFERRED EMBODIMENTS

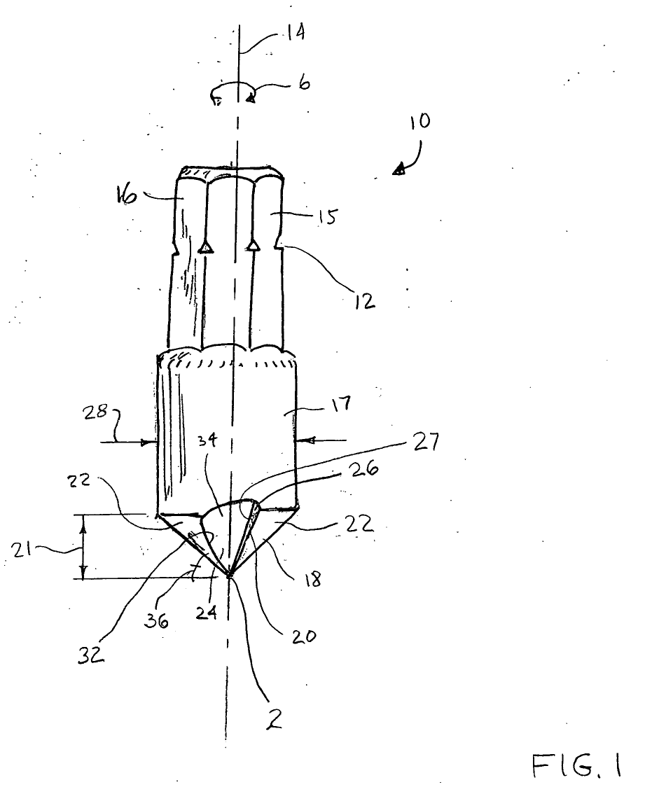

Refer now to FIG. 1 there being shown a countersink bit, generally designated by reference numeral 10, according to a preferred embodiment of the present invention. The countersink bit 10 is generally cylindrical in shape and has a longitudinal axis 14. The countersink bit 10 has an engagement portion 16 and an enlarged cylindrical portion 17. The engagement portion 16 of the countersink bit 10, in use, is engaged with a drill chuck, or other suitable device, for transmitting a rotational force to the countersink bit 10. As shown in FIG. 1, the engagement portion 16 has flat surfaces 15 and notches 12, or alternatively may have a cylindrical surface, for engagement with the drill chuck.

The enlarged cylindrical portion 17 has a diameter 28, and abuts the engagement portion 16 on one end and has conical portion 18 at its other end. The diameter 28 is chosen to equal to the diameter of the desired countersink opening. The diameter 28 of the enlarged cylindrical part 17 in a preferred embodiment is approximately 0.3 inches. Preferably, the diameter 28 is 0.31 inches. The enlarged cylindrical portion 17 may be formed from the same material stock as the engagement portion 16, or, alternatively, can be attached to the engagement portion 16 by brazing, welding, or other suitable means, such as with a fastener. An exemplary material for countersink bit 10 is steel. The conical portion 18 has a point end 2, and is the cutting portion of the countersink bit 10. The conical portion 18 extends an axial length 21 along the longitudinal axis 14 from the point end 2 toward the opposite end of the countersink bit 10. This axial length 21 is essentially the axial length the countersink bit 10 will cut into a work piece, as will be explained in more below. In a preferred embodiment, the axial length 21 can be from approximately 0.17 inches to approximately 0.22 inches. Preferably, the conical section axial length 21 is approximately 0.19 inches.

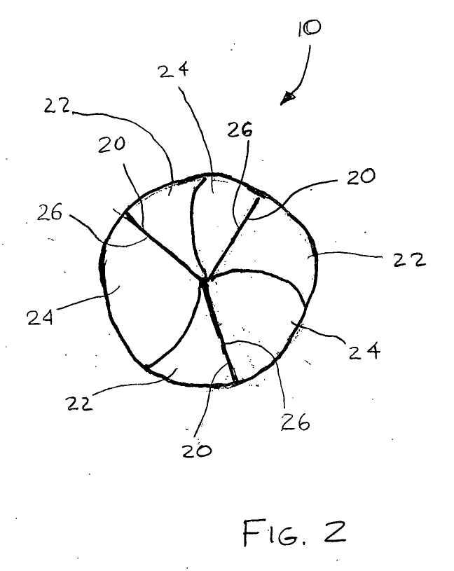

With reference to FIGS. 1 and 2, the conical portion 18 has a plurality of cutting edges 20 defined by cutting faces 26 and flank surfaces 22. In the illustrated embodiment, the countersink bit 10 has three cutting edges 20. The number of the cutting edges 20 may be increased or decreased depending upon the type of material comprising the work piece, the diameter of the countersink bit 10, and other considerations. The conical portion 18 has an angle 36 with respect to a line perpendicular to the longitudinal axis 14, as shown in FIG. 1. In a preferred embodiment, the angle 36 can be from approximately 18 degrees to approximately 72 degrees. Preferably, the angle 36 is approximately 45 degrees.

The cutting faces 26 lie between the cutting edges 20 and bottom edges 27. The cutting faces 26 extend inward from the surface of the conical portion 18 toward the longitudinal axis 14 or axial center of the countersink bit 10. The cutting faces 26, in a preferred embodiment, extend substantially at a right angle from the surface of the conical portion toward the longitudinal axis 14. Alternatively, the cutting faces 26 may be slightly angled forward, such that the cutting edges 20 are slightly forward of the bottom edges 27 in the clockwise cutting direction 6. In the illustrated embodiment, the bottom edges 27 and cutting edges 20 meet at point end 2 such that the cutting faces 26 are generally triangular in shape.

Split surfaces 24 extend between the flank surfaces 22 and the bottom edges 27 of the cutting faces 26. A non-cutting edge 32 extends between each split surface 24 and adjacent flank surface 22. The non-cutting edge 32 is located generally in the conical plane of the conical portion 18. Alternatively, the non-cutting edge 32 may be recessed below the conical plane of the conical portion 18. The spilt surface 24 is cut into the conical portion 18 and forms a reservoir 34, as will be explained in more detail below.

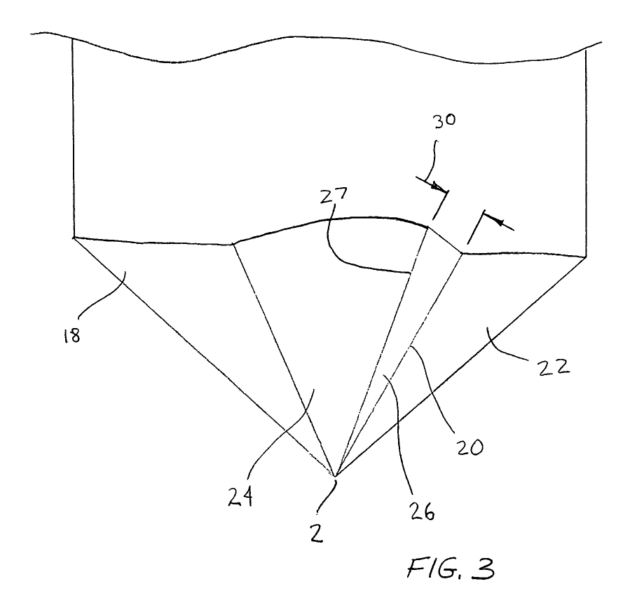

The split surfaces 24 of the countersink bit 10 are shallow due to shallow cutting faces 26 having a minimal depth extending from the respective cutting edge 20 to the respective bottom edge 27 of each cutting face 26. This is an important feature of the invention, and is illustrated in more detail in FIG. 3. As shown in FIG. 3, the cutting face 26 has a depth 30 from the cutting edge 20 to the bottom edge 27. The depth 30 is greatest at the edge of the conical portion 18 away from the point end 2, and decreases toward the point end 2 where the cutting edge 20 and the bottom edge 27 meet. In a preferred embodiment, the depth 30 can be from approximately 0.020 inches to approximately 0.030 inches. Preferably, the depth 30 is approximately 0.026 inches. The cutting face 26 is essentially triangular in shape, as shown.

In use, the countersink bit 10 is used to make countersink openings in composite wood material. When downward force is applied to the rotating countersink bit 10, the conical portion 18 will cut into a work piece. The countersink bit 10 is rotated clockwise in the direction of arrow 6 (FIG. 1) through a rotational force imparted onto the countersink bit 10 from any suitable driving means, such as a drill. Due to the shallow cutting faces 26, generally only the conical portion 18 of the countersink bit 10 penetrates into the composite wood material work piece. The countersink bit 10 penetrates the composite wood material to a depth generally equal to the axial length of the conical portion 18. The penetration of the countersink bit 10 stops because the composite wood material cut by the cutting edges 20 is not removed or otherwise channeled away from the countersink bit 10 by the split surfaces 24, or any other surfaces of the conical portion 18. Rather, the composite wood material cut by the cutting edges 20 is accumulated in the reservoir 34, and, as will be explained below, blocks the cutting edges 20 from cutting into the work piece.

In conventional twist drills and countersink bits, typical flutes provide a path for the cut material to exit the hole. Such flutes, when the conventional countersink bit is rotated, cause cut material to be carried out of the hole being cut and away from the surfaces of the countersink bit. As such cutting edges on conventional drills and countersink bits remain unobstructed by the cut material, and continue to cut into the work piece until manually stopped by the operator. This can lead to excessive cutting into the work piece, which is undesirable. In the countersink bit 10 of the invention, no flutes or other surfaces are provided to remove or carry away cut material from surfaces of the countersink bit 10. Moreover, the novel design having shallow split surfaces 24 and shallow cutting faces 26 form a reservoir 34 which accumulates the cut material. As the cut composite wood material fills the reservoir 34, the cutting edges 20 become blocked by the cut material and thereby inhibited from cutting any further or deeper into the work piece. Thus, due to the shallow cutting faces 26 and the shallow split surfaces 24 of the invention, the depth of the countersink hole is controlled to be approximately the same as the axial length 21 of the conical portion 18.

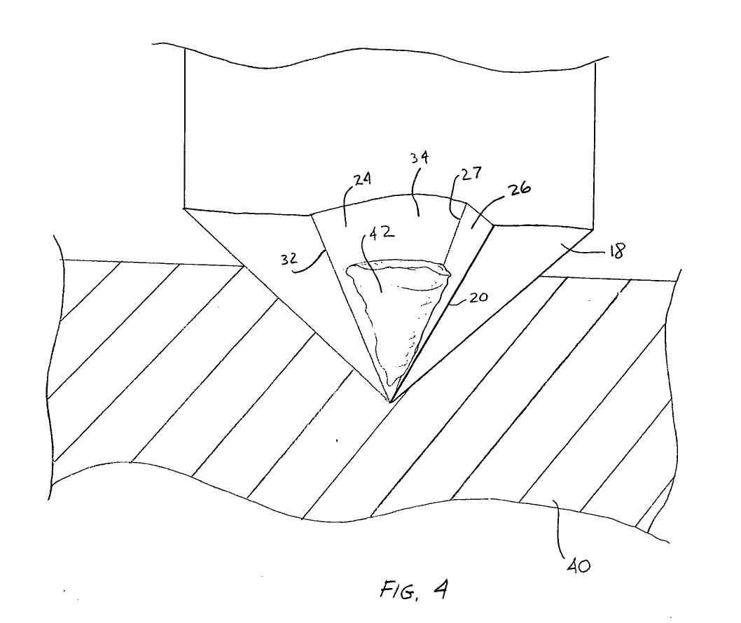

Please refer to FIGS. 4 through 8, which show the countersink bit 10 in use while cutting a countersink hole in a composite wood material 40. FIG. 4 shows the conical portion 18 of the countersink bit 10 that has penetrated slightly more then halfway into the composite wood material 40. At this stage, cut composite wood material 42 begins to accumulate inside the reservoir 34. The cut material is not channeled or otherwise moved away from the countersink bit 10. As shown in FIG. 4, the cut composite wood material 42 is collected in the reservoir 34, namely on the cutting face 26 and extends toward edge 32 of the split surface 24. The cut composite wood material 42 covers the bottom edge 27 of the cutting face 26, and extends along the cutting face 26 toward the cutting edge 20. However, at this stage a portion of the cutting face 26, and more importantly the cutting edge 20, are still exposed. As such, cutting edges 20 continue to cut into the composite wood material 40 as the countersink bit 10 is rotated.

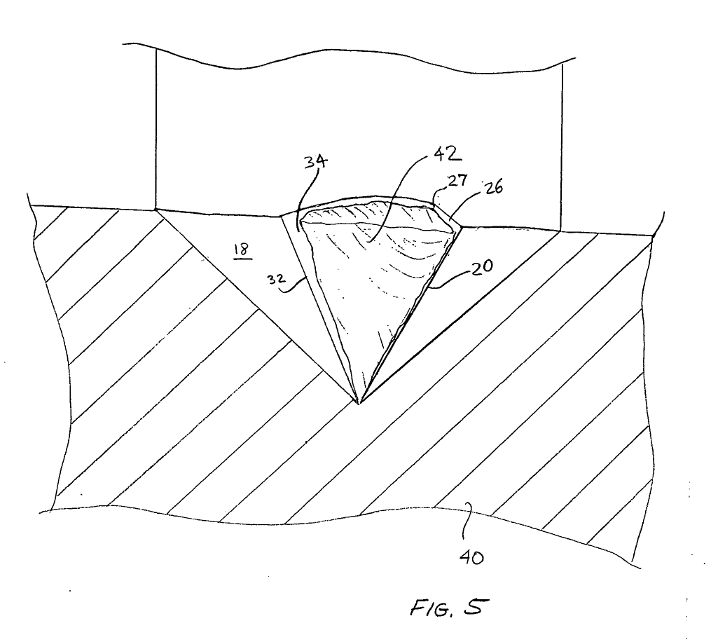

With reference now to FIG. 5, the countersink bit 10 has penetrated the composite wood material 40 a distance approximately equal to the axial length 21 of the conical portion 18. At this stage, the reservoir 34 is filled with cut composite wood material 42. As shown in FIG. 5, enough cut composite wood material 42 has accumulated in reservoir 34 to substantially fill the reservoir 34. At this stage, the cut composite wood material 42 covers the cutting faces 26 from the bottom edges 27 to the cutting edges 20, thereby blocking the cutting edges 20 and preventing the cutting edges 20 from cutting further into the composite wood material 40. As such, the countersink bit 10 of the invention provides different kind of results than would be expected from a conventional countersink bit. Whereas in a conventional bit removal of cut material would be expected, the countersink bit of the invention accumulates cut material to achieve desired results.

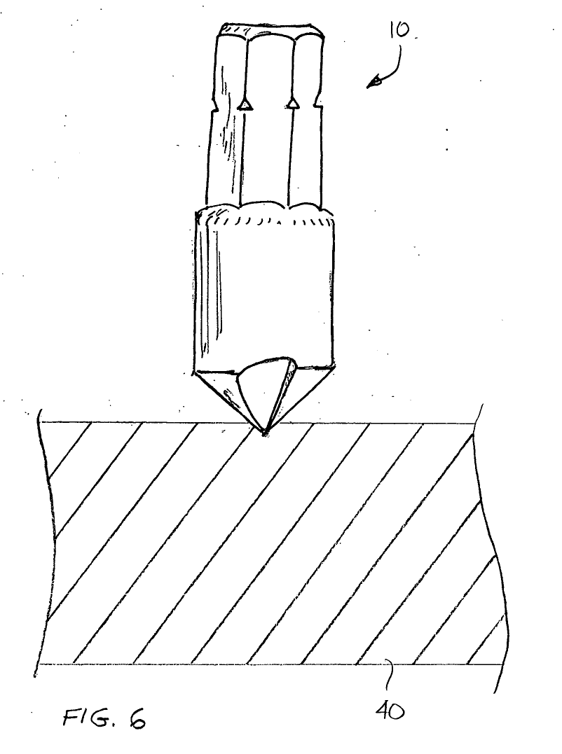

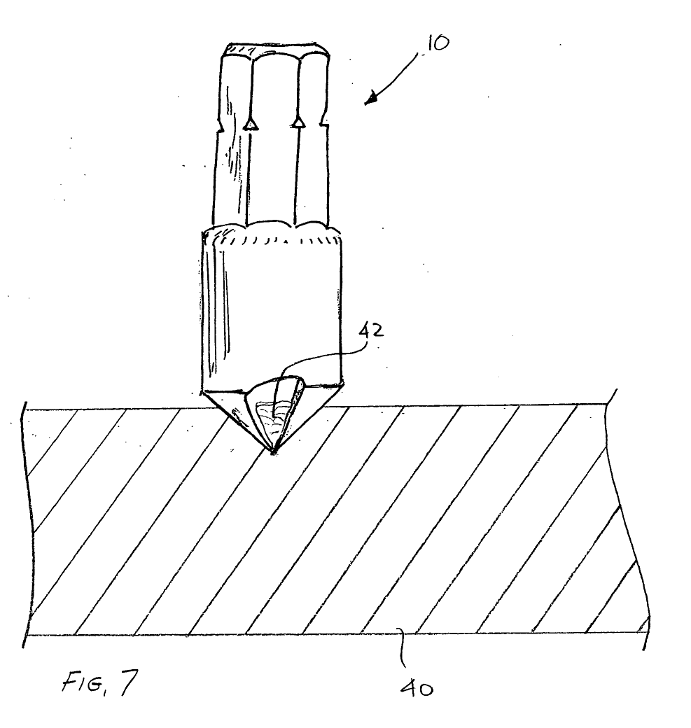

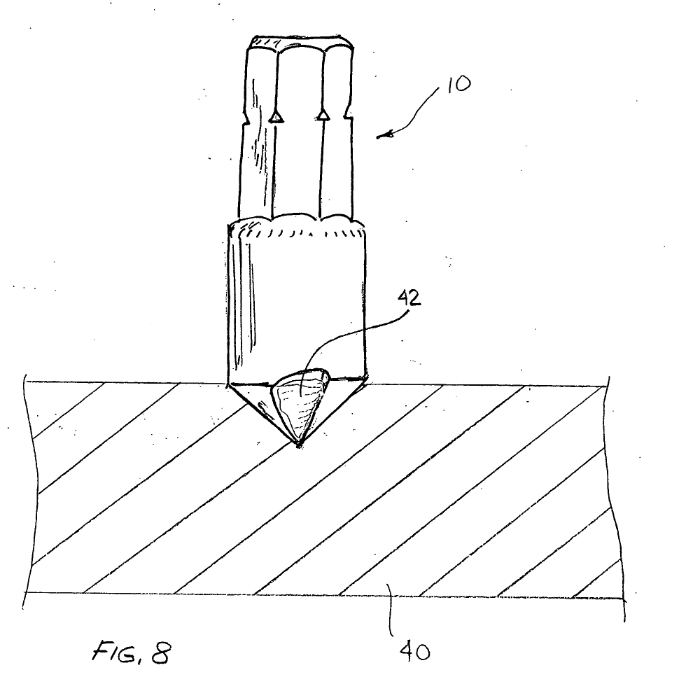

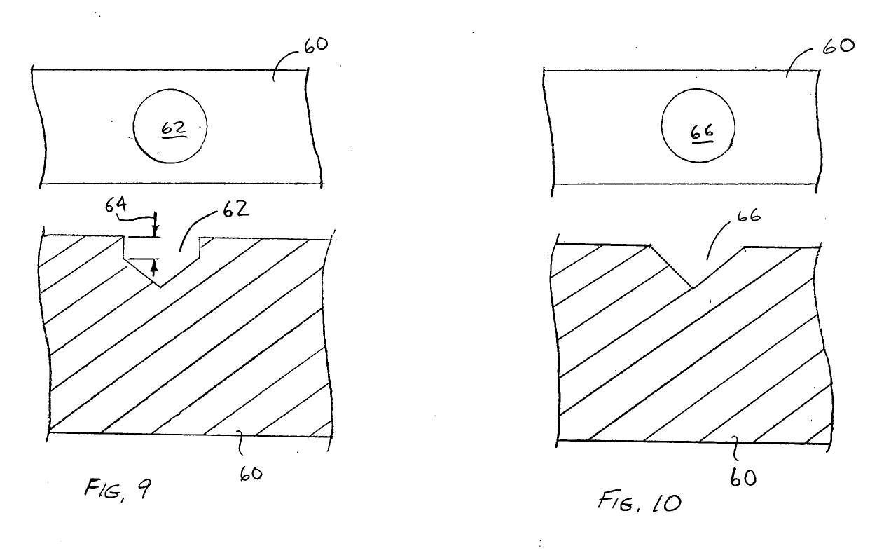

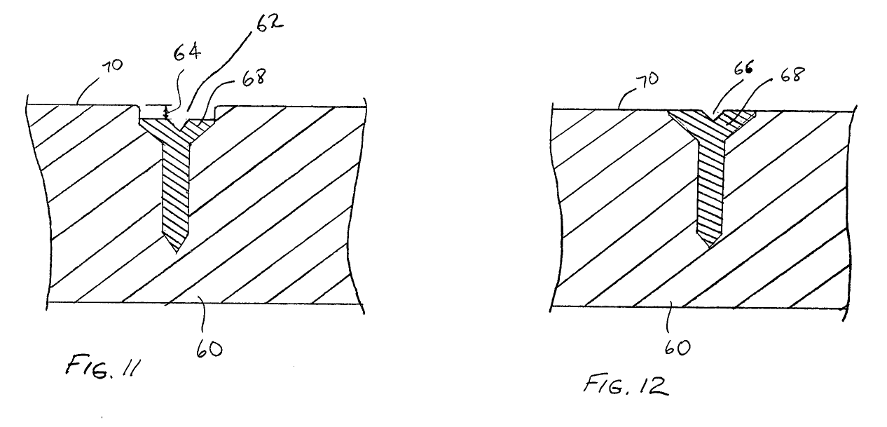

FIGS. 6-8 also illustrate the countersink bit 10 in use. When the countersink bit 10 is first engaged with composite wood material 40, the cutting faces 26 and cutting edges 20 are free of any obstructions and are ready to cut into the composite wood material 40. As the countersink bit 10 penetrates into the composite wood material 40, as shown in FIG. 7, cut composite wood material 42 begins to accumulate in the reservoirs 34 formed by the shallow split surfaces 24 and shallow cutting faces 26. At this stage, not enough of the cut composite wood material 42 has accumulated in the reservoir 34 to block the cutting edges 20 from cutting. Thus, as the countersink bit 10 is rotated it continues to cut into the composite wood material 40.

With reference to FIG. 8, the countersink bit 10 has penetrated the composite wood material 40 to a depth substantially equal to the axial length 21 of the conical portion 18. At this stage, enough cut composite wood material 42 has accumulated in the reservoirs 34 to block the cutting edges 20 of the cutting faces 26. As such, continued rotation of the countersink bit 10 results in no additional cutting into the composite wood material 40 because the cutting edges 20 can no longer cut as they are completely blocked by the cut composite wood material 42. Continued rotation of the countersink bit 10 will not result in additional cutting and penetration into the composite wood material 40. Thus, manual disengagement of the countersink bit 10 is not required at the precise moment when the proper depth of the countersink hole is reached. Rather, the countersink bit 10 of the invention will stop cutting into the composite wood material 40 once the conical portion 18 has penetrated the material 40 up to the axial length 21 of the conical portion 18. Thus the proper depth is maintained, even if rotational force continues to be transmitted to the countersink bit 10.

The above description and drawings are only illustrative of preferred embodiments of the present inventions, and are not intended to limit the present inventions thereto. Any subject matter or modification thereof which comes within the spirit and scope of the following claims is to be considered part of the present inventions.

What is claimed as new and desired to be protected by Letters Patent of the United States is:

1. A countersink bit for composite wood, comprising:
a generally cylindrical body having at one end a cylindrical portion and at the other end an engagement portion;
a conical portion at an end of said cylindrical portion, said conical portion comprising:
a shallow cutting face defined by a cutting edge and a bottom edge;
a shallow split surface, defined on one side by said bottom edge and on the other side by an edge of a flank surface;
wherein said shallow split surface and said shallow cutting face define a reservoir which, in use, accumulates cut composite wood material.

2. The countersink bit of claim 1, comprising at least three shallow cutting faces, shallow split surfaces and flank surfaces.

3. The countersink bit of claim 1, wherein said conical portion has an axial length of from approximately 0.17 inches to approximately 0.22 inches.

4. The countersink bit of claim 1, wherein said conical portion has a point end, and an angle of from approximately 18 degrees to approximately 72 degrees.

5. The countersink bit of claim 1, wherein said shallow cutting face has a depth defined by said cutting edge and said bottom edge of from approximately 0.020 inches to approximately 0.030 inches.

6. The countersink bit of claim 1, wherein said shallow cutting face is a triangular cutting face.

7. The countersink bit of claim 1, wherein said shallow cutting face extends substantially at a right angle from a surface of said conical portion toward a longitudinal axis of said countersink bit.

8. The countersink bit of claim 1, wherein said cylindrical portion is an enlarged cylindrical portion having a diameter of approximately 0.3 inches.

9. A countersink bit having a depth control feature, comprising:
a generally cylindrical body having at one end a cylindrical portion and at the other end an engagement portion;
a conical portion at an end of said cylindrical portion, said conical portion having a depth control feature comprising:
a shallow cutting face defined by a cutting edge and a bottom edge;
a shallow split surface, defined on one side by said bottom edge; and wherein said shallow split surface and said shallow cutting face define a reservoir which, in use, accumulates cut material.

10. The countersink bit of claim 9, comprising at least three shallow cutting faces and shallow split surfaces.

11. The countersink bit of claim 9, wherein said shallow cutting face has a depth defined by said cutting edge and said bottom edge of from approximately 0.020 inches to approximately 0.030 inches.

12. The countersink bit of claim 9, wherein said shallow cutting face extends substantially at a right angle from a surface of said conical portion toward a longitudinal axis of said countersink bit.

13. The countersink bit of claim 9, wherein said shallow cutting face is essentially triangular having a maximum depth approximately equal to 0.026 inches.

14. The countersink bit of claim 9, wherein said conical portion has a depth of from approximately 0.17 inches to approximately 0.22 inches.

15. A method of using a countersink bit in composite wood, the method comprising:
providing a countersink bit having a conical portion with a shallow cutting face and a shallow split surface, wherein said shallow split surface and said shallow cutting face define a reservoir;
providing a rotational force to the countersink bit;
engaging said countersink bit with a composite wood material;
making a countersink opening in said composite wood material by rotating said countersink bit while cut portions of said composite wood material are accumulated in said reservoir, wherein said countersink bit stops penetrating into said countersink opening when said reservoir is substantially filled with said cut portions of said composite wood material.

16. The method of claim 15, wherein said shallow cutting face is defined by a cutting edge, and wherein said cutting edge is blocked by said cut composite wood material when said reservoir is substantially filled with said cut composite wood material.

17. The method of claim 15, comprising proving a countersink bit having a conical portion with three shallow cutting faces and three shallow split surfaces.

18. The method of claim 15, wherein after said reservoir is substantially filled with said cut composite wood material, said countersink bit stops cutting said composite wood material even if continued rotational force is provided to the countersink bit.

19. The method of claim 15, comprising providing a cutting edge and a bottom edge that define a depth of said shallow cutting face, wherein said depth of the shallow cutting face is from approximately 0.020 inches to approximately 0.030 inches.

20. The method of claim 15, comprising providing an essentially triangular shallow cutting face.
